(19) United States
(12) Patent Application Publication
(10) Pub. No.: US 2006/0091334 A1
(43) Pub. Date: May 4, 2006

(54) Con-focal imaging system and method using destructive interference to enhance image contrast of light scattering objects on a sample surface

(76) Inventors: Jan-Peter Urbach, Stadtbergen (DE); Stefan Wurm, Austin, TX (US)

Correspondence Address: SLATER & MATSIL LLP, 17950 PRESTON ROAD, SUITE 1000, DALLAS, TX, 75252, US

(21) Appl. No.: 10/980,082

(22) Filed: Nov. 3, 2004

(51) Int. Cl. G01N 21/88

(52) U.S. Cl. 250/559.45

(57) ABSTRACT

System and method for detecting defects on a sample such as a lithography mask blank or a semiconductor substrate. The con-focal imaging system uses dual beam interference to enhance signal contrast from a light scattering defect on a sample surface. An incoming light beam is split into a probe beam and a reference beam. Destructive interference between the probe beam and the reference beam is established by moving a movable portion of a mirror system, to tune the system. The system is then used to detect defects on the surface of the sample, wherein intensity detected by a detector indicates the presence of a defect on the sample. Destructive interference is used to cancel out and eliminate the directly reflected light, without blocking out the scattered light, resulting in a detection signal that is more sensitive to scattered light than conventional con-focal microscopes.

### TECHNICAL FIELD

The present invention relates generally to a system and method of detecting defects on a surface, and more particularly to a system and method of using destructive interference of a probe beam and a reference beam to enhance image contrast of light scattering objects on a sample surface.

### BACKGROUND

Semiconductor devices are manufactured by depositing many different types of material layers over a semiconductor workpiece or wafer, and patterning the various material layers using lithography. The material layers typically comprise thin films of conductive, semiconductive, and insulating materials that are patterned and etched to form integrated circuits (IC's).

In the semiconductor industry, lithography photomasks are used to image a master pattern onto semiconductor wafers. The master patterns of lithography photomasks need to be free of defects; otherwise, the defects could print onto the wafers and lead to device failures. Defect inspection of lithography photomask blanks is therefore a critical step in integrated circuit manufacturing. As feature sizes on IC's continue to shrink, smaller mask defects need to be found and removed.

For many years, optical lithography techniques such as contact printing, proximity printing, and projection printing have been used to pattern material layers of integrated circuits. Optical lithography techniques use wavelengths of light, such as 248 nm or 193 nm, that are close to the wavelengths of visible light. Optical lithography techniques use transmissive lithography masks for patterning, where light is passed through the lithography mask to impinge upon a wafer. However, as the minimum feature sizes of IC's are decreased, the semiconductor industry is trending towards the use of non-optical lithographic techniques to achieve the decreased feature sizes demanded by the industry. Some non-optical lithographic technologies in development include direct-write electron-beam lithography, projection electron-beam or SCattering with Angular Limitation in Projection Electron beam Lithography (SCALPEL), proximity x-ray lithography, ion-beam lithography, emersion lithography, direct imprinting, and Extreme Ultraviolet Lithography (EUVL).

EUVL extends the principles of projection lithography into the soft x-ray spectrum. A much shorter wavelength, 13.5 nm, is used as the wavelength than is used in optical lithography. In EUVL, a plasma is used to generate a broadband radiation with significant EUV radiation. This plasma is either generated by laser radiation bombarding a target material, or by an electrical discharge. The EUV radiation is collected by a system of mirrors coated with EUV interference films. The EUV radiation is then used to illuminate an EUV reflection lithography mask. The pattern on the lithography mask is imaged and de-magnified onto a resist-coated wafer. The entire lithography mask pattern is exposed onto the wafer by synchronously scanning the lithography mask and the wafer. EUVL is advantageous in achieving a resolution of less than about 0.1 μm and a large depth of focus (DOF), e.g., a DOF of greater than about 1 μm.

In EUVL, transmissive lithography masks cannot be used, because there is no known material that is transmissive for EUV. Therefore, reflective EUV lithography masks are used to form patterns on a wafer in EUVL. For EUVL lithography in particular, producing defect free transmissive lithography masks is important, yet challenging. In order to reduce EUV lithography mask blank defects, inspection tools need to be able to detect defects as small as about 30 nm or less, for example.

Some defect inspection tools currently used to inspect EUV lithography mask blanks and smooth surfaces of semiconductor substrates use a con-focal microscope arrangement that detects changes in light intensity in an image plane. The con-focal microscope concept is based on the fact that light is scattered in non-specular directions if a defect is present on the surface. Inspection systems using conventional confocal microscope setups have been shown to detect particles having a diameter of about 60 nm. Other methods used to inspect EUV lithography masks include dark field inspection tools and actinic inspection tools, as examples.

Con-focal microscopes can be operated in a bright field mode or a dark field mode. If a con-focal microscope is operated in bright field mode, as shown in FIG. 1, light scattered by a defect in the non-specular direction leads to a light intensity reduction in the image plane. A small dip in intensity in the image plane needs to be detected on top of the normal high intensity light signal reflected back from the sample surface, as shown in FIG. 2. If a con-focal microscope is operated in a dark field mode, as shown in FIG. 3, only light reflected in the non-specular direction is sampled. Light reflected back in the specular direction is blocked by an aperture stop, and light scattered in the non-specular direction is directed back into the optical system by mirrors proximate the sample. Light scatter in the non-specular direction is detected in the image plane in addition to the noise floor of specular light that reaches the detector in the image plane.

There are problems in the prior art con-focal microscope defect detection systems shown in FIGS. 1 and 3. For a bright field system shown in FIG. 1, the statistics of the I₀ signal limits resolution. In other words, because the scattered signal does not depend on the reflectivity of the surface, for highly reflective surfaces, the reflected intensity will be relatively large compared to the scattered light intensity. Thus, at some point, the scattered intensity will be smaller than the intrinsic noise.

For a dark field detection system shown in FIG. 3, the aperture blocks a large part of the scattered intensity, which is being measured. Thus, the detection signal is reduced and defects are difficult to detect. Also, there is a noise floor of specular reflected light, since the aperture of the system cannot be closed completely, because otherwise no light would reach the detector at all. This further makes the detection of defects difficult with this system.

Thus, what is needed in the art are improved systems and methods of detecting defects on lithography masks.

### SUMMARY OF THE INVENTION

These and other problems are generally solved or circumvented, and technical advantages are generally achieved, by preferred embodiments of the present invention, which provide systems and methods of optimizing con-focal microscopes when used as a defect inspection tool.

In accordance with a preferred embodiment of the present invention, a method of detecting defects on a surface of a sample includes providing a con-focal microscope, the con-focal microscope including a plurality of lenses, a detector, and a plate comprising a pinhole disposed between the plurality of lenses and the detector. A mirror system is disposed proximate the con-focal microscope, the mirror system comprising a first semi-transparent mirror and a movable mirror portion. The method includes illuminating the first semi-transparent mirror of the mirror system with a light beam, wherein the first semi-transparent mirror splits the light beam into a probe beam and a reference beam. The probe beam is reflected onto a first portion of the sample, the first portion having no defects formed thereon. The probe beam is then reflected towards the detector of the con-focal microscope. The reference beam is reflected towards the movable mirror portion of the mirror system and then towards the detector of the con-focal microscope. The position of the movable mirror portion of the mirror system is adjusted such that destructive interference occurs between the probe beam and the reference beam. The surface of the sample is scanned for defects, wherein incomplete destructive interference between the probe beam and the reference beam detected by a non-vanishing light intensity at the detector indicates the presence of a defect on the sample.

In accordance with another preferred embodiment of the present invention, a system for detecting defects on a surface of a sample includes a con-focal microscope and a mirror system proximate the con-focal microscope. The con-focal microscope includes a plurality of lenses, a detector, and a plate comprising a pinhole disposed between the plurality of lenses and the detector. The mirror system comprises a semi-transparent mirror and a movable mirror portion. The semi-transparent mirror is adapted to split an incoming light beam into a probe beam and a reference beam. The position of the movable mirror portion may be adjusted such that destructive interference between the probe beam reflected from a defect-free portion of the sample and the reference beam occurs. The system is adapted to scan the surface of the sample for defects, wherein incomplete destructive interference between the probe beam and the reference beam detected by a non-vanishing light intensity at the detector indicates the presence of a defect on the surface of the sample.

Advantages of embodiments of the present invention include increasing the sensitivity of defect measurements, compared to conventional microscopes in the art. Embodiments of the invention can detect defects having diameters of about 30 nm or less, for example. Therefore, the systems and methods described herein are particularly useful in detecting defects on EUVL lithography mask blanks, for example. Novel methods and systems of detecting defects on surfaces of a variety of types of samples, such as transmissive lithography mask blanks, reflective lithography mask blanks, or semiconductor devices having smooth surfaces formed thereon, are provided by embodiments of the invention, as examples. Destructive interference is used to cancel out and eliminate directly reflected light, without blocking out the scattered light, resulting in a detection signal that is more sensitive to scattered light.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a prior art con-focal bright field defect detection system;

FIG. 2 is a graph of the light intensity measured by the detection system shown in FIG. 1;

FIG. 3 shows a prior art con-focal dark field defect detection system;

FIG. 4 is a graph of the light intensity measured by the detection system shown in FIG. 3;

FIG. 5 shows a novel defect detection system in accordance with an embodiment of the present invention, wherein a probe beam and a reference beam are used to detect defects on a sample;

FIG. 6 shows graphs illustrating how the phase and amplitude of the reference beam in FIG. 5 may be tuned;

FIG. 7 shows a cross-sectional view of a lithography mask blank having defects disposed thereon that may be scanned for defects using the novel defect detection system shown in FIG. 5;

FIG. 8 shows a cross-sectional view of a semiconductor device having a smooth surface with defects disposed thereon that may be scanned for defects using the defect detection system shown in FIG. 5; and

FIG. 9 shows a detection signal generated by an embodiment of the invention, having no background noise.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely method of detecting defects on lithography mask blanks. Defects on optical lithography mask blanks and/or non-optical lithography mask blanks, or on transmissive or reflective lithography mask blanks, may be detected using the systems and methods described herein. The invention may also be applied, however, to other applications where detecting defects on a surface is desired, such as the detection of defects on a flat or planar surface of a semiconductor device, as an example.

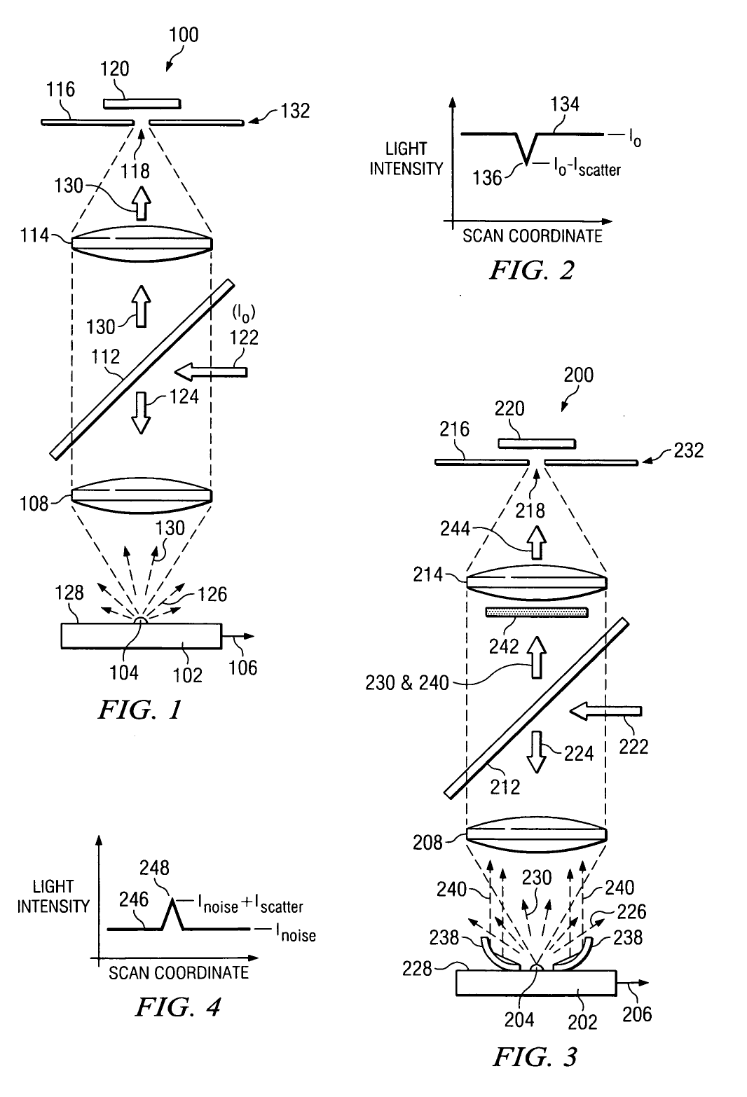

FIG. 1 and FIG. 3 illustrate the principles used in con-focal bright field and dark field defect detection, respectively. Referring first to FIG. 1, a prior art method of using a con-focal microscope to detect defects in a bright field mode will next be described. The system 100 includes a semi-transparent mirror 112 that reflects optical light 122/124 (e.g., at a wavelength of about 248 nm) through a lens 108 onto a sample 102 which may comprise a lithography mask blank. The sample 102 is located in an object plane 128 and may be moved in a scan direction 106 in order to detect defects. Light 130 is reflected back towards and recollected by the lens 108, through the semitransparent mirror 112 and through a lens 114 disposed proximate a detector 120. A plate 116 comprising a pinhole 118 in the image plane 132 of the lens 114 is disposed between the lens 114 and the detector 120. The size of the pinhole 118 is a function of the sensitivity of the optical system 100, and may comprise about 1 μm, for example.

In the system shown in FIG. 1, to detect a defect 104 on the sample 102, a beam of light 122 is directed towards the mirror 112, which reflects off of the mirror 112 towards the lens 108, and is focused by the lens 108 as a reflected beam 124 onto a small spot on the sample 102. The sample 102 reflects the light, and the reflected light 130 is collected by the same lens 108. The reflected light beam 130 passes through the mirror 112 and is imaged or refocused by lens 114 onto the pinhole 118. The detector 120 collects the intensity of the reflected light 130 passing through the pinhole 118, giving a measurement signal of light intensity 10, shown in the graph of FIG. 2.

If a defect 104 exists on the surface of the sample 102, a portion 126 of the light beam 124 is scattered by the defect 104 in a non-specular direction. In a bright field defect detection system, light 130 is collected that is directly reflected from the sample 102. The pinhole size 118 is selected such that a large part of the refocused spot will pass through the pinhole 118. The scattered light 126 tends to broaden and weaken the spot in the image plane 132. The broadening of the scattered light 126 occurs because the scattered light 126 looses its phase relationship with the specular reflected light 130. The weakening is due to the fact that some amount of the scattered light 126 is emitted in directions that are not collected by the lens 108. Since in a broader spot, the pinhole 118 blocks a larger amount of the total intensity in the spot, both effects decrease the intensity that passes through the pinhole 118 and is collected by the detector 120.

A graph showing light intensity detected by the detector 120 of a con-focal bright field defect detection system 100 for a plurality of scan coordinates on a sample 102 is shown in FIG. 2. If no defect 104 is present on the sample 102, the light intensity 10 measured is a relatively constant signal and is substantially equal to the light intensity of the light beam 122 input to the system 100, as shown at 134. If there is no defect 104, in an ideal system 100, the signal I₀ comprises 100% reflection, and there is no light scattering 126, for example. However, if a defect 104 is present on the sample 102, the defect 104 scatters some amount 126 of the incoming light in all directions, and the light intensity measured by the detector 120 is decreased, as shown at 136 in FIG. 2, indicating (I₀−I_{scatter}). Thus, an intensity reduction 136 in the light intensity measurement indicates a defect 104 on the sample 102. The light intensity may comprise a photocurrent of a photodiode, in mA, or other forms of signals, depending on the type of detector 120 used in the system 100.

A con-focal dark field defect detection system 200 is shown in FIG. 3. Like numerals are used as reference numbers for the various elements shown as were used in FIG. 1. In this system 200, light 240 that is scattered from the sample 202, rather than light 230 being directly reflected from the sample 202, is measured. The system 200 includes mirrors 238 proximate the sample 202 for collecting scattered or non-specular reflected light 240 that occurs when a defect 204 is detected. Both the scattered light 240 and the directly reflected light 230 are reflected back through the lens 208 and the semitransparent mirror 212. To detect the amount of scattered light 240, most of the light 230 that is directly reflected is blocked using an aperture stop 242 disposed between the lens 214 and the mirror 212. The aperture stop 242 allows some of the scattered light 240 to pass through to the detector 220 through the pinhole 218 in the image plane 216.

A property of scattered light is that it is scattered in all directions, including in the directly reflected direction, e.g., in the same direction as light 230. Therefore, a portion of the scattered light 240 is also blocked by the aperture stop 242. The aperture stop 242 excludes most of the directly reflected or specular reflection light 230, passing light 244, which comprises a portion of the scattered light 240, through to the lens 214. The scattered light 244 that passes by the aperture stop 242 is focused by the lens 214 onto the detector 220, through the pinhole 218 in the plate 216.

A graph showing light intensity detected by the detector 220 of the con-focal dark field defect detection system 200 of FIG. 3 for a plurality of scan coordinates on a sample 202 is shown in FIG. 4. The signal Iₙₒᵢₛₑ represents the amount of specular reflected light 230 that is not blocked by the aperture stop 242. If no defect 204 is present on the sample 202, the light intensity measured is relatively constant and is substantially equal to a detected noise level Iₙₒᵢₛₑ of the system 200, as shown at 246. However, if a defect 204 is present on the sample 202, the light intensity measured by the detector 220 is increased, as shown at 248, and is substantially equal to Iₙₒᵢₛₑ+I_{scatter}. Thus, an increase 248 in the light intensity measurement indicates the presence of a defect 104 on the sample 202.

There are problems with the prior art defect measurement systems 100 and 200 shown in FIGS. 1 and 3. For a bright field defect detection system 100 shown in FIG. 1, the statistics of the detected light signal I₀ limit sensitivity. The amount of scattered light is relatively small compared to the intensity I₀, making it difficult to detect defects. Small defects may go unnoticed, as their signal is in the order of the statistical noise in I₀. For a dark field defect detection system 200 shown in FIG. 3, the aperture 242 blocks most of the specular reflected light 130 but also a large amount of the scattered light 226 intensity. The relative size of the scattered intensity compared to the specular reflected intensity is increased because the scattered light 226 is scattered in a wider range of angles. However, the absolute intensity of the scattered light reaching the detector 220 is considerably decreased, and thus, is more difficult to detect.

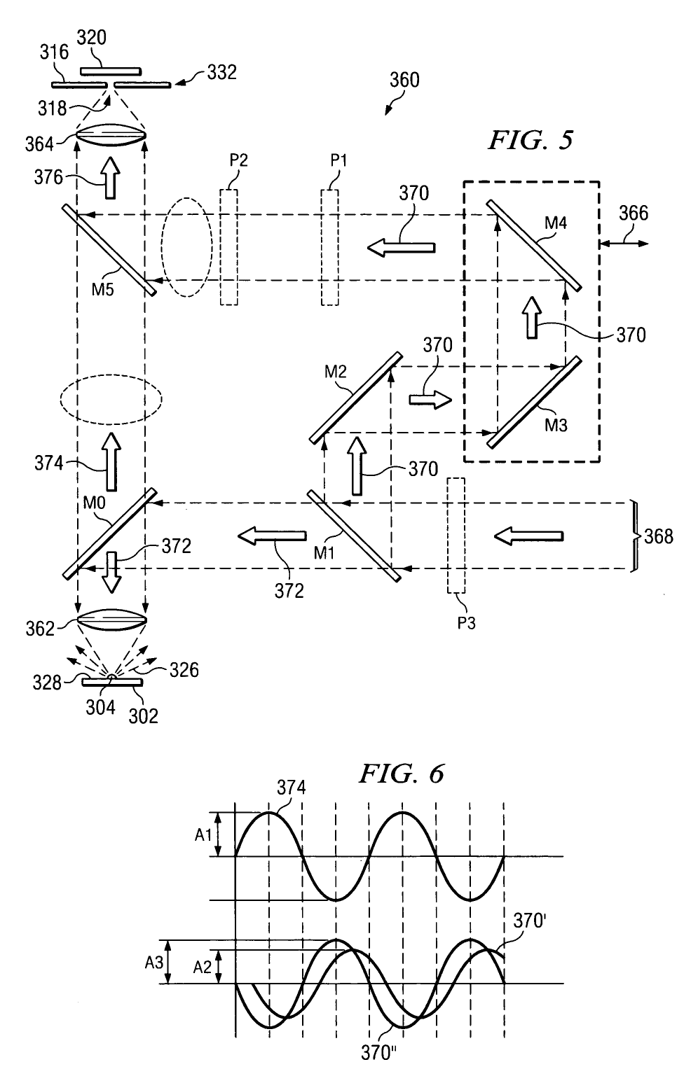

Embodiments of the present invention achieve technical advantages by using a dual beam interference con-focal imaging system 360 to measure defects on a sample 302, as shown in the schematic of FIG. 5. Again, like numerals are used as reference numbers for the various elements shown in FIG. 5 as were used in FIGS. 1 and 3. To avoid repetition, each reference number shown in FIG. 5 is not described again in detail herein. Rather, similar materials x02, x04, x20, etc. are preferably used for the elements and components of the system 360 shown as were described for FIGS. 1 and 3, where x=1 in FIG. 1, x=2 in FIG. 3, and x=FIG. 5.

The novel con-focal imaging system 360 uses dual beam interference to enhance signal contrast from a light scattering defect 304 on a sample 302 surface, by eliminating the specular intensity through destructive interference. Two beams 370 and 372 are used to create interference; one beam 372 that probes the sample 302 surface, referred to herein as a probe beam 372, and another beam 370 that does not probe the sample 302 surface, referred to herein as a reference beam 370. An incoming light beam 368, e.g., comprising an optical light beam, is introduced to the system 360, after passing through a polarization filter P3, disposed between the incoming light beam 368 and a semi-transparent mirror M1, as shown. A semi-transparent mirror M1 reflects part of the beam 368, creating a reference beam 370 that is transmitted to a plurality of mirrors M2, M3, M4, and M5, as shown. The mirrors M2, M3, M4, and M5 create an optical delay path. Mirrors M2, M3 and M4 preferably comprise reflective mirrors, and mirrors M1 and M5 preferably comprise semi-transparent mirrors, for example. The polarization filter P3 defines the polarization of the incoming light beam 368.

The other part of the incoming light beam 368 passes through the semi-transparent mirror M1, creating a probe beam 372 that is transmitted to a semi-transparent mirror M0. The probe beam 372 is reflected off of the mirror M0 and is focused by lens 362 onto the surface of the sample 302 in an object plane 328. If a defect 304 is present on the sample 302 surface, light from the probe beam 372 is scattered.

The unscattered light of the probe beam 372 is reflected back from the surface of the sample 302 as reflected probe beam 374. The reflected probe beam 374 passes through the lens 362, the semi-transparent mirror M0, and the semi-transparent mirror M5. The reflected probe beam 374 is focused through lens 364 and passes through the pinhole 318 in the image plane 316 to the detector 320. The reference beam 370 is transmitted through polarization filters P1 and P2, shown in phantom, and the reference beam 370 is reflected off of the semi-transparent mirror M5 towards the lens 364, which focuses the reference beam 370 and reflected probe beam 374 as a combined beam 376 onto the pinhole 318. Any light passing through the pinhole 318 is collected by the detector 320. Thus, the reference beam 370 and the reflected probe beam 374 are rejoined in the optical system 360 in mirror M5, as a combined beam 376; ideally the reference beam 370 and the reflected probe beam 374 are superimposed as planar waves.

In the novel defect detection design 360, the optical path difference between the reference beam 370 and the reflected probe beam 374 is adjusted by moving the position of the mirrors M3 and M4 so that the two wavefronts from the reference beam 370 and from the reflected probe beam 374 being reflected from a defect free planar sample 302 surface (i.e., a mirror-like surface) interfere destructively in the image plane 332. The relative intensities or amplitudes of the reflected probe beam 374 and the reference beam 370 preferably are adjusted so that the detector signal in the image plane 332 is minimized, e.g., by using the two optional beam polarization filters P1 and P2, as shown.

After tuning the system 360 by moving mirrors M3 and M4, and the beam polarization filters P1 and P2, any disturbance of the reflected probe beam 374 wavefront by a light scattering defect 304 on a sample 302 causes a signal increase in the detector 320. In addition, a decrease in the intensity of the reflected probe beam 374 will also lead to a signal change in the detector 320.

If the light 326 scattered in non-specular directions is sampled and directed back into the system 360, e.g., using mirrors 240 proximate the sample 302, as shown for the dark-field con-focal system 200 in FIG. 3, this also leads to a detector 320 signal increase in the image plane 332, because the path length between the scattered light 326 and the reference beam will be different than that between the reference beam and the probe beam.

The novel system 360 uses a Michelson interferometer theory of creating interference by splitting a single beam into two beams, reflecting the two beams by different path lengths, and bringing the beams together, creating interference. The system 360 is tuned to create destructive interference between the reflected probe beam 374 and the reference beam 370. After tuning the system 360, any intensity detected by the detector 320 indicates a defect 304 on the sample 302. Therefore, the system 360 has no background noise. Also because the specular intensity is eliminated by destructive interference rather than by an aperture block (such as aperture block 242 shown in FIG. 3), the maximum possible amount of scattered light is collected.

Advantageously, the optical path delay of the reference beam 370 with respect to the reflected probe beam 374 can be adjusted in accordance with embodiments of the present invention, as shown in FIG. 6. If the reference beam 370′ is out of phase with the reflected probe beam 374 due to the increased length of the optical path of the reference beam 370′, for example, the reflective mirrors M3 and M4 may be moved with respect to reflective mirror M2 and semi-transparent mirror M5, respectively, to adjust the phase so that the reference beam 370″ is 180 degrees out of phase with the reflected probe beam 374, so that the tuned reference beam 370″ and the reflected probe beam 374 will destructively interfere, canceling one another.

Similarly, the optional beam polarization filters P1 and P2 may be rotated with respect to one another to adjust the amplitude A2 of the reference beam 370′ to an amplitude A3, wherein A3=A1, in order to match the amplitude A1 of the reflected probe beam 374, also shown in FIG. 6. By adjusting the relative intensity or amplitude A2 of the reference beam 370′ to amplitude A3, as reflected back from a clean, defect-free sample 302 surface, the system 360 can be adjusted such that destructive interference of the two beams 370 and 374 in the image plane 332 results a vanishing light intensity at the detector 320.

Alternative methods may be used to create a beam delay for the reference beam 370; for example, as an alternative to the moveable mirrors M3 and M4, beam delays used in other interferometer types may also be used. Likewise, adjusting the relative intensity of the two beams 370 and 374 by using two crossed variable polarization filters P1 and P2 in the reference beam path is an example of a method of adjusting the relative signal intensity of the two beams 370 and 374; other methods may alternatively be used. For example, an acousto optical modulator may be used. In this embodiment, unpolarized light may be used, e.g., polarization filters P1, P2 and P3 are not included in the system 360.

According to the embodiment of the present invention using the polarization filters P1, P2 and P3, changes induced in the polarization of a reflected probe beam 374 caused by a light scattering defect 304 on a sample 302 may be used in a polarized light dual beam interference microscope. In this embodiment, the probe beam passes through a polarization filter after being reflected from the sample 304 surface. A change in the polarization of the light reflected from the surface of the sample 302 due to a defect 304 causes a changed signal intensity in the image plane 332 where the two beams 370 and 374 interfere destructively.

The novel system 360 and methods described herein may be implemented with several types of con-focal microscopes available on the market. As an example, a con-focal microscope comprising lenses 362, 364, and detector 320 may comprise a M350 or M1350 con-focal microscope supplied by Lasertech in Japan, although alternatively, other con-focal microscopes may be used.

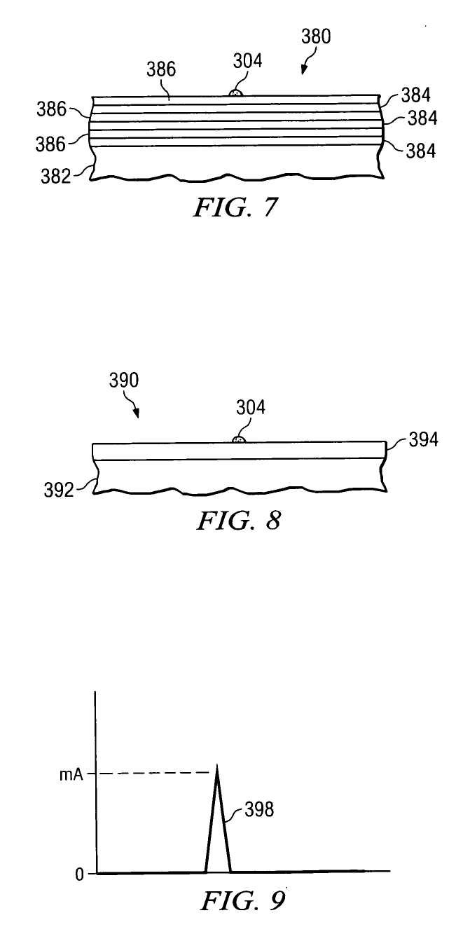

FIG. 7 shows a cross-sectional view of a lithography mask blank 380 having defects 304 disposed thereon that may be scanned for defects 302 using the novel defect detection system 360 shown in FIG. 5. The mask blank 380 may comprise a substrate 382 comprising a low thermal expansion material. If the mask blank 380 comprises a EUVL mask blank 380, a plurality of layers 384/386 may be formed over the substrate 382. The layers 384/386 provide reflectivity to EUV radiation and may comprise alternative layers of molybdenum and silicon; e.g., 40 to 50 bilayers 384/386 may be formed over the substrate 382. The top surface of the mask blank 380 is substantially smooth except for the defect 304 formed thereon, for example. The lithography mask blank 380 is an example of a sample 304 (see FIG. 5) that may be tested for defects using the system 360 and methods described herein.

FIG. 8 shows a cross-sectional view of a semiconductor device 390 having defects disposed thereon that may be scanned for defects using the defect detection system shown in FIG. 5. The semiconductor device 390 is another example of a sample 304 (see FIG. 5) that may be tested for defects using the system 360 and methods described herein. The semiconductor device 390 may comprise a workpiece 392. The workpiece 392 may include a semiconductor substrate comprising silicon or other semiconductor materials covered by an insulating layer, for example. The workpiece 392 may also include other active components or circuits formed in a front end of line (FEOL), not shown. The workpiece 392 may comprise silicon oxide over single-crystal silicon, for example. The workpiece 392 may include other conductive layers or other semiconductor elements, e.g. transistors, diodes, etc. Compound semiconductors, GaAs, InP, Si/Ge, or SiC, as examples, may be used in place of silicon. For example, the workpiece 392 may include component regions or various circuit elements formed therein. A material layer to be patterned 394 is formed over the workpiece 392, as shown. A defect 340 may be present on the top surface of the material layer 394, as shown, which is detectable using the system 360 and methods described herein.

It may be desirable in some manufacturing situations to detect defects on planar surfaces of a semiconductor device 390. For example, it may be desirable to ensure that the defect 304 level is below a certain level, to ensure adequate yields. The production line of semiconductor devices 390 may be monitored to ensure that the number of defects 304 stays below a particular statistical limit, for example.

However, in most applications, patterned lithography masks need to be 100% defect free: it is intolerable to have defects on patterned lithography masks, because the lithography masks are templates for the integrated circuits being manufactured. If a lithography mask level has a defect formed thereon, all the integrated circuits patterned using the mask will have the defect.

Thus, embodiments of the present invention may be used in the detection of defects 304 in a variety of aspects. Lithography mask blanks such as the one shown in FIG. 7 may be scanned for defects 304 using the system 360 shown in FIG. 5. If it is determined that the mask blank 380 has too many defects, the mask blank 380 may be scrapped, for example. Alternatively, the mask blank 380 may be reworked, e.g., one or more material layers 384/386 may be removed, and redeposited over the same substrate 382, to salvage the substrate 382 and reduce costs. Or, the defects 304 might be removed after detection, by cleaning the lithography mask blank 380 using cleaning solutions or laser based particle removal techniques, as examples. Yet another possibility is to repair the defect, e.g., by removing the topmost bilayers together with the defect by ion sputtering.

In some applications, once the location of the defects 304 are noted on the lithography mask blank 380, the pattern of the mask may be shifted so that the defects 304 reside under an opaque area or other area, so that the defect 304 will not be transferred to a semiconductor device during the patterning process, for example. Because most semiconductor devices comprise many levels of material layers, there are usually several masks required for one semiconductor device. A mask pattern may be selected that the defect 304 will not be a problem for; e.g., a lithography mask blank 380 having many defects 304 formed thereon may be used for a mask level pattern wherein the defects 304 will not be transferred to a semiconductor device.

Advantages of embodiments of the invention include providing a system 360 for detecting defects using a con-focal detection method having increased sensitivity. A system 360 having the ability to detect defects having a width of about 30 nm to 60 nm or less is achieved herein. Therefore, the system 360 described herein is particularly useful in detecting defects on EUVL lithography mask blanks, for example. The system 360 described herein provides novel methods of detecting defects on surfaces of a variety of types of samples 302, such as transmissive lithography mask blanks and reflective lithography mask blanks 380 or semiconductor devices 390, as examples. A signal 398, shown in FIG. 9, is generated at the detector 320 that has no background noise, so that a signal 398 having a maximum intensity indicates the presence of defects 304 on a sample 302. In accordance with embodiments of the present invention, destructive interference is used to cancel out and eliminate the directly reflected light, without blocking out the scattered light, resulting in a detection signal 398 that is more sensitive to scattered light.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of detecting defects on a surface of a sample, the method comprising:
providing a con-focal microscope, the con-focal microscope including a plurality of lenses, a detector, and a plate comprising a pinhole disposed between the plurality of lenses and the detector;
disposing a mirror system proximate the con-focal microscope, the mirror system comprising a first semi-transparent mirror and a movable mirror portion;
illuminating the first semi-transparent mirror of the mirror system with a light beam, wherein the first semi-transparent mirror splits the light beam into a probe beam and a reference beam;
reflecting the probe beam onto a first portion of the sample, the first portion of the sample having no defects formed thereon, and then reflecting the probe beam towards the detector of the con-focal microscope;
reflecting the reference beam towards the movable mirror portion of the mirror system and then towards the detector of the con-focal microscope;
adjusting the position of the movable mirror portion of the mirror system such that destructive interference occurs between the probe beam and the reference beam; and
scanning the surface of the sample for defects, wherein incomplete destructive interference between the probe beam and the reference beam detected by a non-vanishing light intensity at the detector indicates the presence of a defect on the surface of the sample.

2. The method according to claim 1, further comprising adjusting the intensity of the reference beam so the reference beam has substantially the same intensity as the probe beam.

3. The method according to claim 2, further comprising disposing a first polarization filter between the light beam and the first semi-transparent mirror, and a second polarization filter and a third polarization filter between the mirror system and the con-focal microscope, wherein the third polarization filter defines the polarization of the light beam, and wherein adjusting the intensity of the reference beam comprises using the second polarization filter and the third polarization filter to adjust the intensity of the reference beam.

4. The method according to claim 2, further comprising providing an acousto optical modulator, wherein adjusting the intensity of the reference beam comprises using the acousto optical modulator.

5. The method according to claim 2, wherein an intensity difference detected by the detector indicates the presence of a defect on the sample.

6. The method according to claim 1, wherein the sample comprises a transmissive lithography mask blank, a reflective lithography mask blank, or a semiconductor workpiece having a substantially smooth surface.

7. The method according to claim 1, wherein scanning the surface of the sample comprises detecting defects comprising a width of about 30 nm or less.

8. The method according to claim 1, wherein providing the con-focal microscope comprises providing a con-focal microscope including a first lens proximate the detector and a second lens proximate the sample, wherein disposing the mirror system includes disposing a mirror system including a second semi-transparent mirror proximate the first lens, a third semi-transparent mirror proximate the second lens, and a first reflective mirror proximate the first semi-transparent mirror, and wherein disposing the mirror system includes disposing a mirror system including a movable mirror portion comprising a second reflective mirror proximate the first reflective mirror and a third reflective mirror disposed between the second reflective mirror and the second semi-transparent mirror.

9. The method according to claim 8, wherein adjusting the position of the movable mirror portion comprises moving the second reflective mirror towards or away from the first reflective mirror, and moving the third reflective mirror towards or away from the second semi-transparent mirror.

10. The method according to claim 8, wherein reflecting a probe beam comprises passing the probe beam through the first semi-transparent mirror, reflecting the probe beam from the third semi-transparent mirror to the second lens, through the second lens to the sample, from the sample back through the second lens, through the third semi-transparent mirror, through the second semi-transparent mirror, and through the first lens to the detector.

11. The method according to claim 8, wherein reflecting a reference beam comprises reflecting the reference beam from the first semi-transparent mirror to the first reflective mirror, from the first reflective mirror to the second reflective mirror, from the second reflective mirror to the third reflective mirror, from the third reflective mirror to the second semi-transparent mirror, from the second semi-transparent mirror through the first lens and to the detector.

12. The method according to claim 1, wherein the probe beam comprises a first phase and a first intensity, wherein the reference beam comprises a second phase and a second intensity, and wherein adjusting the position of the movable mirror portion of the mirror system comprises adjusting the second phase to be 180 degrees out of phase with the first phase.

13. The method according to claim 12, further comprising adjusting the second intensity to equal the first intensity.

14. The method according to claim 1, wherein adjusting the position of the movable mirror portion of the mirror system comprises adjusting the position of the movable mirror so that the light intensity at the detector is substantially zero.

15. A system for detecting defects on a surface of a sample, the system comprising:
a con-focal microscope, the con-focal microscope including a plurality of lenses, a detector, and a plate comprising a pinhole disposed between the plurality of lenses and the detector; and
a mirror system proximate the con-focal microscope, the mirror system comprising a semi-transparent mirror and a movable mirror portion, wherein the semi-transparent mirror is adapted to split an incoming light beam into a probe beam and a reference beam, wherein the position of the movable mirror portion may be adjusted such that destructive interference between the probe beam reflected from a defect-free portion of the sample and the reference beam occurs, wherein the system is adapted to scan the surface of the sample for defects, and wherein incomplete destructive interference between the probe beam and the reference beam detected by a non-vanishing light intensity at the detector indicates the presence of a defect on the surface of the sample.

16. The system according to claim 15, further comprising means for adjusting the intensity of the reference beam so the reference beam has substantially the same intensity as the probe beam.

17. The system according to claim 16, further comprising a first polarization filter adapted to define the polarization of the incoming light beam, and wherein the means for adjusting the intensity of the reference beam comprises a second polarization filter and a third polarization filter disposed between the mirror system and the con-focal microscope.

18. The system according to claim 16, wherein the means for adjusting the intensity of the reference beam comprises an acousto optical modulator.

19. The system according to claim 16, wherein an intensity difference detected by the detector indicates the presence of a defect on the sample.

20. The system according to claim 15, wherein the sample comprises a transmissive lithography mask blank, a reflective lithography mask blank, or a semiconductor workpiece having a substantially smooth surface.

21. The system according to claim 15, wherein defects comprising a width of about 30 nm or less are detectable on the surface of the sample.

22. The system according to claim 15, wherein the con-focal microscope comprises a first lens proximate the detector, and a second lens proximate the sample, wherein the mirror system includes a second semi-transparent mirror proximate the first lens, a third semi-transparent mirror proximate the second lens, and a first reflective mirror proximate the first semi-transparent mirror, wherein the movable mirror portion of the mirror system comprises a second reflective mirror proximate the first reflective mirror and a third reflective mirror disposed between the second reflective mirror and the second semi-transparent mirror.

23. The system according to claim 22, wherein the position of the movable mirror portion may be adjusted for destructive interference between the probe beam reflected from a defect-free portion of the sample and the reference beam by moving the second reflective mirror towards or away from the first reflective mirror, and moving the third reflective mirror towards or away from the second semi-transparent mirror.

24. The system according to claim 22, wherein a probe beam may be reflected through the system by passing the probe beam through the first semi-transparent mirror, reflecting the probe beam from the third semi-transparent mirror to the second lens, through the second lens to a sample, from the sample back through the second lens, through the third semi-transparent mirror, through the second semi-transparent mirror, and through the first lens to the detector.

25. The system according to claim 22, wherein a reference beam may be reflected through the system by reflecting the reference beam from the first semi-transparent mirror to the first reflective mirror, from the first reflective mirror to the second reflective mirror, from the second reflective mirror to the third reflective mirror, from the third reflective mirror to the second semi-transparent mirror, from the second semi-transparent mirror through the first lens and to the detector.

26. The system according to claim 15, wherein the probe beam comprises a first phase and a first intensity, wherein the reference beam comprises a second phase and a second intensity, and wherein adjustment of the position of the movable mirror portion of the mirror system adjusts the second phase to be 180 degrees out of phase with the first phase.

27. The system according to claim 26, further comprising means for adjusting the second intensity to equal the first intensity.
